(19) United States
(12) Patent Application Publication
(10) Pub. No.: US 2003/0034757 A1
(43) Pub. Date: Feb. 20, 2003

(54) Utilizing portable electrical power sources

(76) Inventor: Douglas J. Woodnorth, Needham, MA (US)

Correspondence Address: FISH & RICHARDSON PC, 225 FRANKLIN ST, BOSTON, MA, 02110, US

(21) Appl. No.: 09/729,634

(22) Filed: Dec. 4, 2000

(51) Int. Cl. H02J 7/00

(52) U.S. Cl. 320/132

(57) ABSTRACT

Information such as usage or acquisition terms of a portable electrical power source, such as a battery or a battery-powered device, is used to determine a fee. The information may be communicated to an external device, e.g., over the Internet, or to a vending apparatus which recharges the battery or dispenses a fresh battery.

### TECHNICAL FIELD

This invention relates to utilizing portable electrical power sources.

### BACKGROUND

A battery is a typical portable power source. Ordinarily, a battery is purchased by a user who installs it in an electrically powered device. When the battery is completely discharged, it is most often discarded and the user buys a new one to replace it. In the case of rechargeable batteries, the user also buys a charger. The charger is an adapter that allows the user to recharge batteries from, for example, a conventional wall outlet which draws low cost power from a utility. Rechargeable batteries can be charged a finite number of times before they too need to be replaced. The chargers as well have a limited lifetime. When the rechargeable battery or charger is no longer operable, the user buys another. The price of the battery or charger is based on the cost of manufacture. The manufacturer's profit is the price at which the battery or charger is sold, less manufacturing and business costs.

### SUMMARY

In an aspect, the invention features recording the usage of a portable power source, a battery for example, and/or the acquisition terms, e.g., the fee, under which the battery is provided to the user. As the battery is used, or when it is replaced or recharged, the user is billed an amount based on the usage and/or the acquisition terms. An advantage of embodiments is that the use of batteries can be made more convenient and less expensive. Two primary deterrents to battery use, particularly rechargeable battery use, can be mitigated: the initial purchase cost of a battery and/or a charger, and the inconveniences often associated with replacement and/or recharging. In particular, the need for the user to transport the recharger with the battery can be avoided. For example, the battery and/or recharger may be provided to a user at low cost or even free. As usage is recorded, the user is billed a use fee over time. Alternatively, the user may pay a higher acquisition fee. In this case, the cost of subsequent recharges or replacements may be lower or free. In addition, by recording usage and/or acquisition terms and utilizing this information for billing, charging or replacement stations can be located in a variety of public and private settings such as airports, lodging establishments, and the like, freeing the user from transporting a charger and/or making it easier to obtain a fresh, charged battery.

In another aspect, the invention features providing a battery to a user and communicating battery usage to a remote monitor.

In another aspect, the invention features providing a battery or a battery-powered device to a user, determining the usage of the battery or the device, and/or the terms of providing the battery or device, and determining a fee based on the usage and/or the terms.

In another aspect, the invention features a battery including an electronically readable identification module and a usage module.

In another aspect, the invention features a battery having attached thereto an electrically readable terms module, including a representation of battery acquisition and/or recharge terms.

In another aspect, the invention features a vending station including a device or battery recharging or dispensing apparatus, and a terms module for determining the terms under which a battery or device will be recharged or dispensed.

In another aspect, the invention features a battery charging apparatus including a communication module capable of facilitating communication related to the use of the charger or a battery installed in the charger.

In another aspect, the invention features an external monitor including a communication module adapted to receive a communication of battery identification and/or usage, an account storage module to store the identification and usage information, and a billing module to initiate billing based on the identification and usage information.

In another aspect, the invention features an external monitor including a communication module adapted to receive a communication of terms and/or usage of a battery and/or device, and a transaction computer adapted to compute a fee based on the terms and/or usage.

In another aspect, the invention features a system for using a battery or battery-powered device including a battery or battery-powered device having an identification module, a battery usage and/or terms detector, an external monitor capable of receiving identification and/or usage and/or terms information, and a communication apparatus for communicating identification and/or usage and/or terms information to the external monitor.

Embodiments may include one or more of the following. The usage is communicated by transmitting a signal representative of the usage over the Internet. The usage is communicated by a wireless channel. A communication with the user is based on the usage. A bill based on the usage is communicated. The bill is communicated to the user by the Internet. The battery is provided to the user without a purchase fee. The battery is in a device provided to a user without a purchase fee. The device is a communication device. The usage is communicated by the device. The battery is a rechargeable battery. The battery is a single use battery. The battery usage is based on recharge cycles. The usage and/or terms are communicated to an external monitor. The usage and/or terms are transmitted over the Internet. The usage and/or terms are recorded in a module attached to the battery, the device, or a recharger for recharging the battery or device.

Embodiments may also include one or more of the following. A plurality of vending stations are provided that dispense and/or recharge the battery or device, where the fee for replacement or recharging is based on the usage and/or the terms. A rechargeable battery or a device with a rechargeable battery is provided. A single-use battery or battery-powered device with a single use battery is provided. The battery includes a communication device facilitating communication of usage to an external device. The battery further includes a battery device detector that detects the device in which the battery is installed. The battery device detector verifies the installed device as a permissible device. The battery includes a disabler capable of disabling battery use.

Embodiments may include one or more of the following. The vending station includes a module for determining from a battery or device previous terms under which the battery or device was provided to a user and/or recharged. The vending station includes an identification apparatus which determines whether a battery or device is suitable for recharge or replacement. The vending station includes a device or battery receiving apparatus that receives a battery or device from a user. The vending apparatus includes a payment receptacle capable of receiving payment. The charging apparatus includes an identification module. The charging apparatus includes a verification module for verifying an installed battery/or device as a permissible battery and/or device. The charging apparatus includes a disabler.

Embodiments may include one or more of the following advantages. The convenience of battery use can be greatly enhanced. In addition, the overall cost of portable-energy usage can be reduced by encouraging the utilization of secondary renewable and rechargeable sources over single use primary batteries. For example, a typical three-pack of AAA-size batteries may have a manufacturing cost of about $0.60, a wholesale cost of about $1.50, and a retail cost of $3.00. The service time is typically around 5 hours, which yields a cost of $0.60/use-hour. A typical rechargeable lithium-cadmium battery, on the other hand, may have a manufacturing cost of about $5.00, a wholesale cost of about $10.00, and a retail cost of about $25.00. The battery can be recharged 500 cycles which a service time of 3 hours each for a total use cost of only $0.02/hr. As a result, by making more convenient the use of such sources, the cost of portable power may be reduced.

Other features, objects, and advantages follow.

### DESCRIPTION OF DRAWINGS

FIG. 1 is a schematic illustrating a battery usage communication system;

FIG. 2 is a more detailed schematic illustrating a system using a rechargeable battery and a charger;

FIG. 3 is a schematic of a battery module to facilitate usage communication, while FIG. 3A is a schematic of the recharger module, and FIG. 3B is a schematic of a usage monitor module;

FIG. 4 is a flow diagram of the operation of the battery module and charger module; and

FIG. 4A is a flow diagram of the operation of a usage monitor;

FIG. 5 is a schematic illustrating systems utilizing various communication modes and charging sources;

FIG. 6 is a schematic illustrating a portable power vending system;

FIGS. 7 and 7A illustrate battery and vending station modules; and

FIG. 8 is a flow diagram of vending station operation.

Like reference symbols in the various drawings indicate like elements.

### DETAILED DESCRIPTION

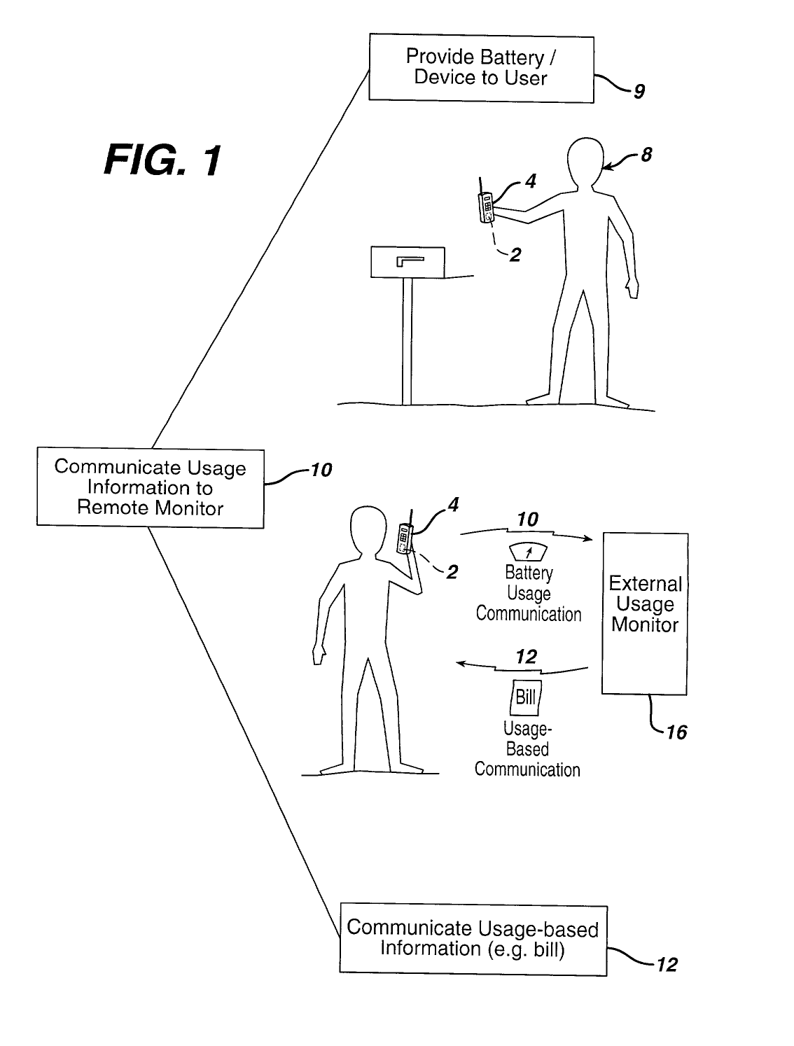

Referring to FIG. 1, a battery usage system includes a battery 2, which may be installed in a device such as a cellular phone 4, and an external usage monitor 6 which is illustrated in this embodiment as a remote monitor that is not powered by the battery itself. The user 8 may receive 9 the battery and/or the device in the mail, for example, at a low or no cost. As the device is used, the battery is discharged. The power usage is communicated 10 to the external usage monitor 6. The monitor can then send a usage-based communication 12, for example, a bill, to the user.

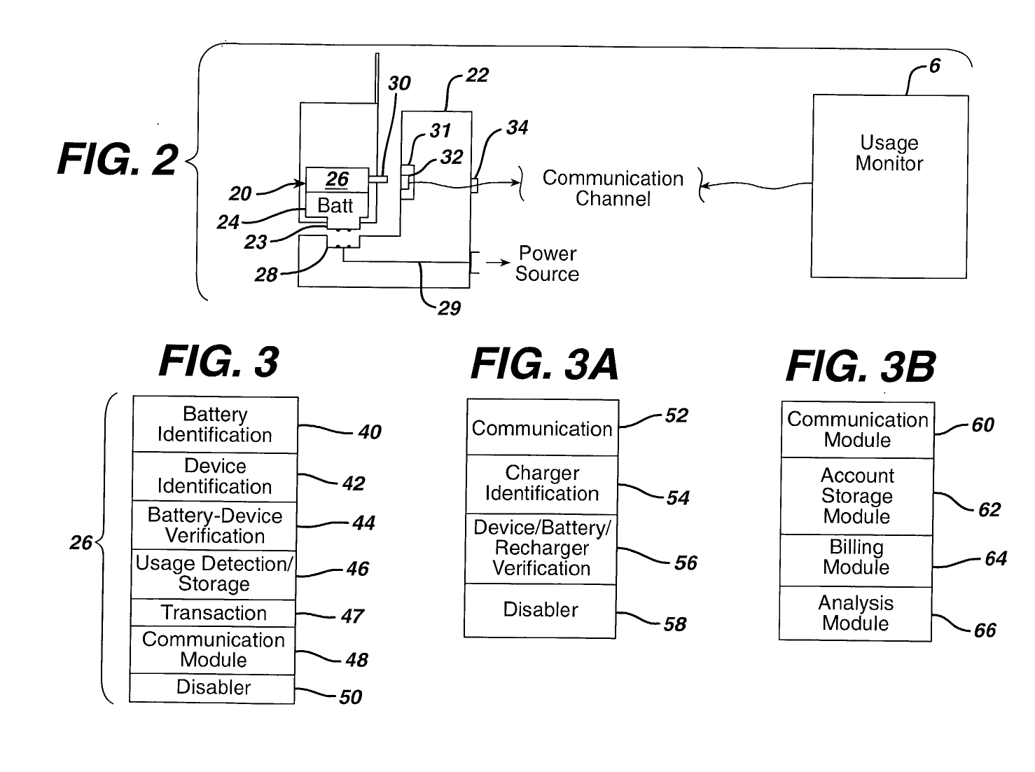

Referring as well to FIG. 2, the system may include a device with a rechargeable battery 20 and an external charger 22. The battery 20 has a power production portion 24, including a recharge port 23, and a module 26 for facilitating communication via a connector 30. The charger 22 has a recharge port 28 which mates with the battery port 23 and connects 29 to an outside power source, such as a conventional wall socket. The charger also includes a module 31 including a connection port 32 which mates with connector 30 of the battery module 26. The module 31 on the charger communicates with battery module 26 and can provide information from or to remote usage monitor 6 via a communications port 34 connected to a communication channel, such as a telephone line, cable, or wireless communication route.

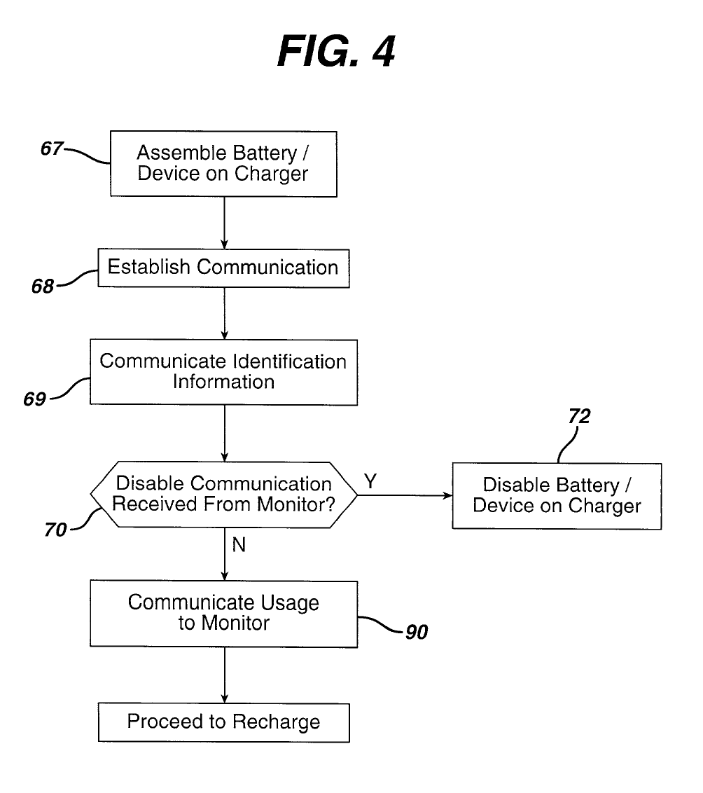

Referring as well to FIG. 3, the battery module 26 includes a number of submodules, including a battery identification module 40 that identifies the battery, and a device identification module 42, which identifies the device in which the battery is being used. (The device identification module may, for example, read the device identification from a module in the device.) The battery module 26 also includes a battery-device verification module 44, which senses whether the battery is installed in a compatible or authorized device. The verification may include verification logic which compares the device identification and battery identification to a table of permissible battery-device combinations.

The battery module 26 also includes a usage detection and storage module 46 that measures the energy discharged from the battery and stores this information. The measure of energy discharged may be a measure of the actual energy output, for example, by measuring watt-hours, or it may be an indication of the number of times the battery has been recharged. The usage may also be based on the usage of the device, such as the on-time of the device or the number of times the device has been turned on and off. The measure of energy discharged may also be an indirect measure, such as the amount of time that the battery has been installed in the device, with power usage being calculated from an assumed, measured, or estimated rate of device usage. Alternatively, the battery module may measure the amount of energy provided to the battery during recharging. The module may also measure the battery use as a function of power output over time.

The battery module 26 may also include a transaction module 47, which records previous transaction history, e.g., the price term, under which the battery and/or charger were provided to the user and/or the fee for previous recharge(s). This information may be recorded at the time of manufacture or at the time the battery is provided to the user by a communication device at the point of sale or it may be communicated to the module by the usage monitor.

The battery module 26 may also includes a communication module 48 to communicate the usage and transaction information. The communication module 48 may include, for example, a modem to permit transmission of data over a conventional phone line. Communication module 48 may also effect communication through the host 48 device in which the battery is installed, e.g., a telephone, personal digital assistant, or computer. The battery module 26 also includes a disabler 50 which can disable further use of the battery or device. For example, the disabler may disable the battery or device if the battery is not installed in a permissible device as determined by the verification module. In this way, if the battery is removed by an unauthorized user, it cannot be used in a random device. The disabler may be made programmable by the user to permit use in selected devices or may be programmable remotely through a communication from the battery owner/manufacturer. For example, the battery may be disabled if a failure to pay a use fee is determined.

Referring to FIG. 3A, the module 31 on the charger also includes a number of submodules. In this example, these include a communication module 52 which permits communication of battery information stored in the battery usage module to the usage monitor 6 and can communicate information either stored in the charger module or from the monitor to the battery. The communication module 52 on the charger may be an alternative or in addition to the communication module 48 on the battery. The communication module 50 includes a connection to a communication channel, such as a phone line and may include a modem. The module 31 on the charger also includes a charger identification module 54, a device/battery/recharger verification module 56, and a disabler 58. The device/battery/recharger verification module 56 compares the device and/or battery identification and the charger identification against permissible combinations and activates the disabler 58 if an attempt is made to recharge an unauthorized battery or device. The verification module 56 can be programmed by the user or the owner/manufacturer to only permit selected devices or batteries to be charged using the charger. The verification module may also send a communication to the usage monitor 6 when an attempt has been made to perform an unauthorized recharge so that the usage monitor 6 can then notify the user that the attempt has been made and that the recharger has been disabled.

Referring as well to FIG. 3B, the usage monitor 6 also includes a series of submodules. In the embodiment illustrated, the monitor includes a communication module 60 to receive communications, including usage information from the module 31 on the charger or the module 26 on the battery. The communication module also sends communications to the user or to other parties (e.g. a third party billing agent such as credit card company). The monitor 6 also includes an account storage module 62 which stores the received information for each battery and/or device. For example, the information may be stored in an account file for the device/battery/user, which may also include payment history and other data, such as usage patterns. A billing module 64 initiates a billing function based on the usage information. The billing module may, for example, transmit a bill electronically to the user back through a device in which the battery is installed or it may signal a conventional billing system which assembles a bill that is communicated by mail. Alternatively, the billing module may charge against a third party account such as a credit card or a debit account.

The usage monitor also includes an analysis module 66 to analyze usage and other data. For example, the analysis module may monitor the historical usage of the device, battery, and/or the charger. When the device, battery or charger approaches the end of its life, the analyzer can execute a communication to the user that it is time, to obtain a new battery or a communication to a battery provider indicating that a new battery should be provided to the user. The analyzer can also utilize the billing data to, for example, provide discounts to certain user classes, e.g., heavy users, or offer premium services such as improved, newly developed battery or recharger technology. The analyzer may determine the power consumption drawn from the battery and adjust the billing to require higher rates for high power applications compared to lower power applications. The analyzer can also utilize the battery transaction information stored in battery transaction sub-module 47. For example, if the battery were provided to the user for a low fee or free, the bill for recharge may be higher compared to a transaction where the user paid a higher fee to obtain the battery. The fee may be based on usage of and/or terms of providing the battery, the device and/or the charger.

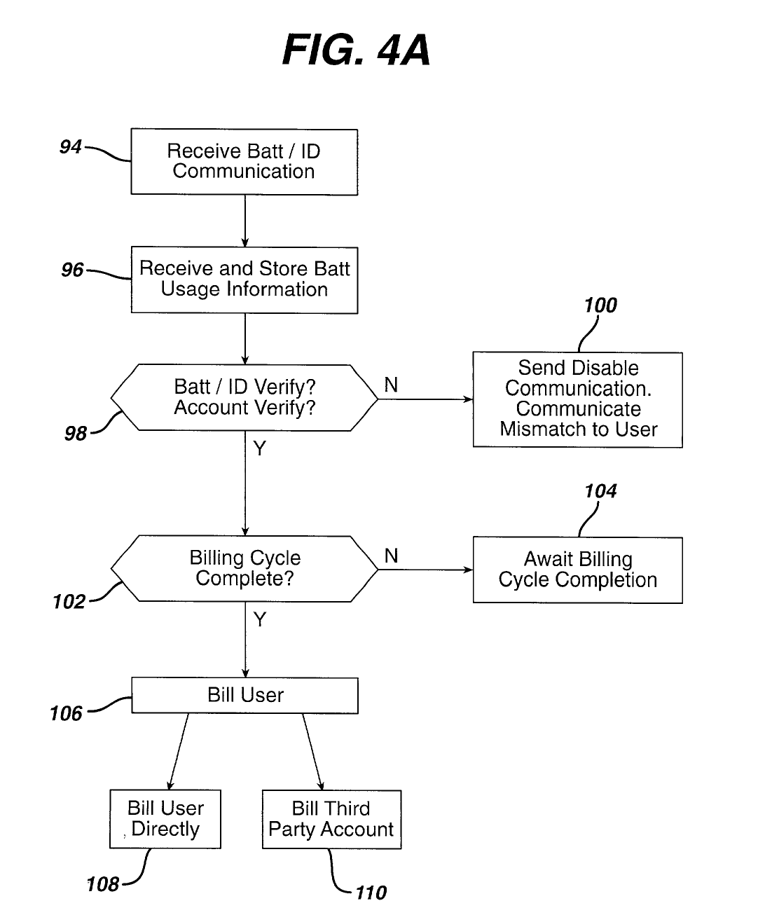

Referring to FIG. 4, an example of the operation of the battery and charger modules at the time of recharging is illustrated. When the battery or device with battery is connected to the charger, a communication link with the usage monitor 6 is established 68 and identification information is communicated 69 to the usage monitor. The system first determines 70 whether the monitor has sent a disable communication. If a disable communication has been sent, the battery, device and/or charger is then disabled 72. If no disable communication has been received, then the usage is communicated 90 to the monitor and recharging of the battery proceeds 92. In embodiments, before establishing the communication link to the monitor, the system may determine whether the usage should be communicated to the monitor. For example, if the usage has been minimal or if less than a predetermined time period has passed, the usage is not communicated to the monitor and the recharge proceeds. By not communicating usage in short time frames, for example, less than 10% of a billing cycle, or small usage amounts, for example 5% or less of the battery capacity, communication traffic is reduced.

Referring now to FIG. 4A, an example of the operation of the usage monitor is illustrated. The usage monitor receives communication from the charger including the battery/device/recharger identification information 94 and the usage information 96. The usage information is correlated based on the identification information with the user and the usage information may be stored in a user account. The identification information is verified 94. If the battery/device/recharger identification does not represent an authorized combination or, if for some other reason, a disable is warranted, e.g., a delinquent payment, the usage monitor 6 sends 100 a disable instruction to the recharger to disable the battery and/or the device. The monitor may also send a communication notifying the user of an unauthorized use. The verification may be in addition to the verification of the charger and the battery or in embodiments the charger and battery verification modules may be omitted.

The usage monitor checks 102 whether the billing cycle is complete. The billing cycle may be based, for example, on time passed or on an amount of power or device usage. If the cycle is not complete, the monitor 6 awaits 104 billing cycle completion. If the billing cycle is complete, the monitor initiates 106 billing the user. The billing may be made directly to a user account 108 or charged to a third party account, such as a credit card company.

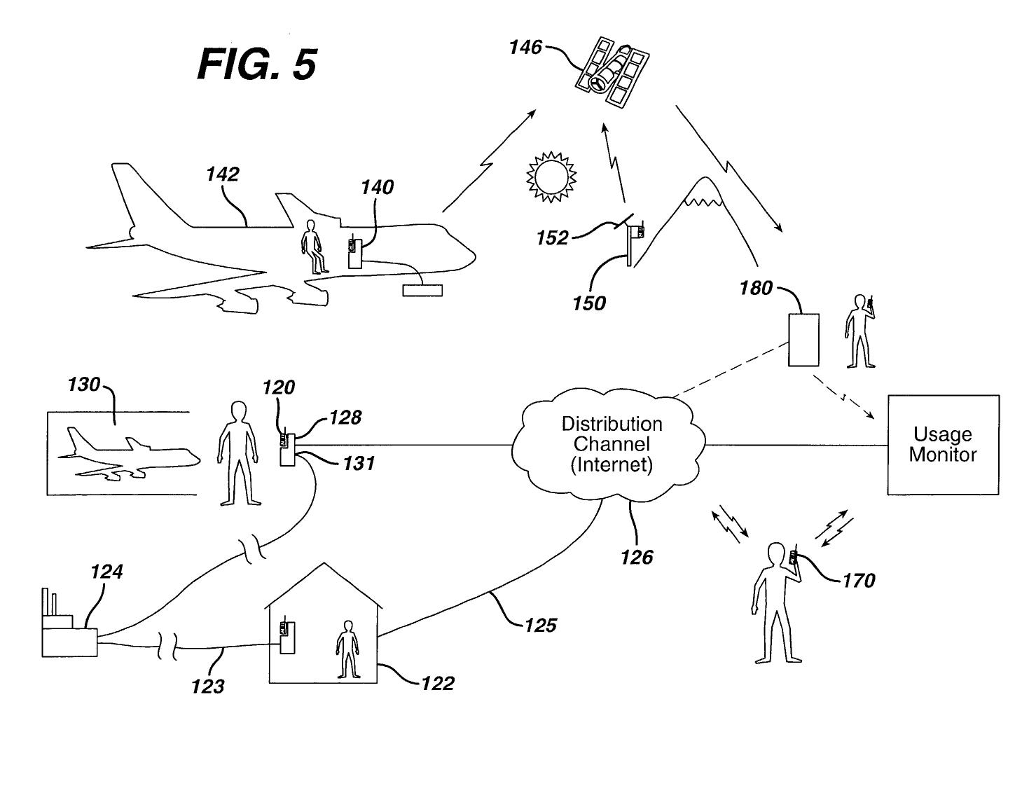

Referring now to FIG. 5, the system can use a number of communication pathways and recharging sources. For example, a device 120 may be recharged at a residence 122 using a connection 123 to a commercial utility 124. Usage information may be communicated by a connection 125 to a distribution channel 126, in this case, the Internet. The device 120 may also be recharged at a public charging station 128 placed in a public locale such as an airport 130. The charging station 128 includes a connection 131 to commercial power generator 124 and connection 132 to the distribution channel 126. In this case, the communicated information includes identification of the charging station to permit tracking of the station use and renumeration to the facilities or parties that permit and maintain the station.

The device 120 may be recharged at a mobile charging station 140, for example, on a vehicle such as an airplane 142. The mobile station includes connection to mobile power source 144 such as the vehicle power generation unit. The charger includes a link to mobile communication means such as a satellite communication link 146 or a Bluetooth protocol. The mobile communication link may be direct to the usage monitor or may be to the distribution channel 126.

The device may also be recharged at a remote charging station 150. The remote station may include its own power source, such a solar panel 152, for charging the battery. The charging station 150 also includes a communication link, e.g., satellite link, to the usage monitor or to the distribution channel.

The usage communication system can also be used without a charging station. In this case, a device 170 communicates over the distribution channel 176 or directly with the monitor. The communication link may be a wired or, as illustrated, a wireless link. The device 170 is preferably a communication device such as a telephone, pager, fax machine, computer, or personal digital assistant. Alternatively, the battery module may include a submodule that permits a communication link from the battery itself to the distribution channel or directly to the monitor. The usage information can be communicated in continuous real time.

In embodiments, the device or battery may be recharged or replaced at an external vending station 180 which may or may not communicate with a central monitor. For example, vending station 180 may dispense charged batteries in exchange for a discharged battery.

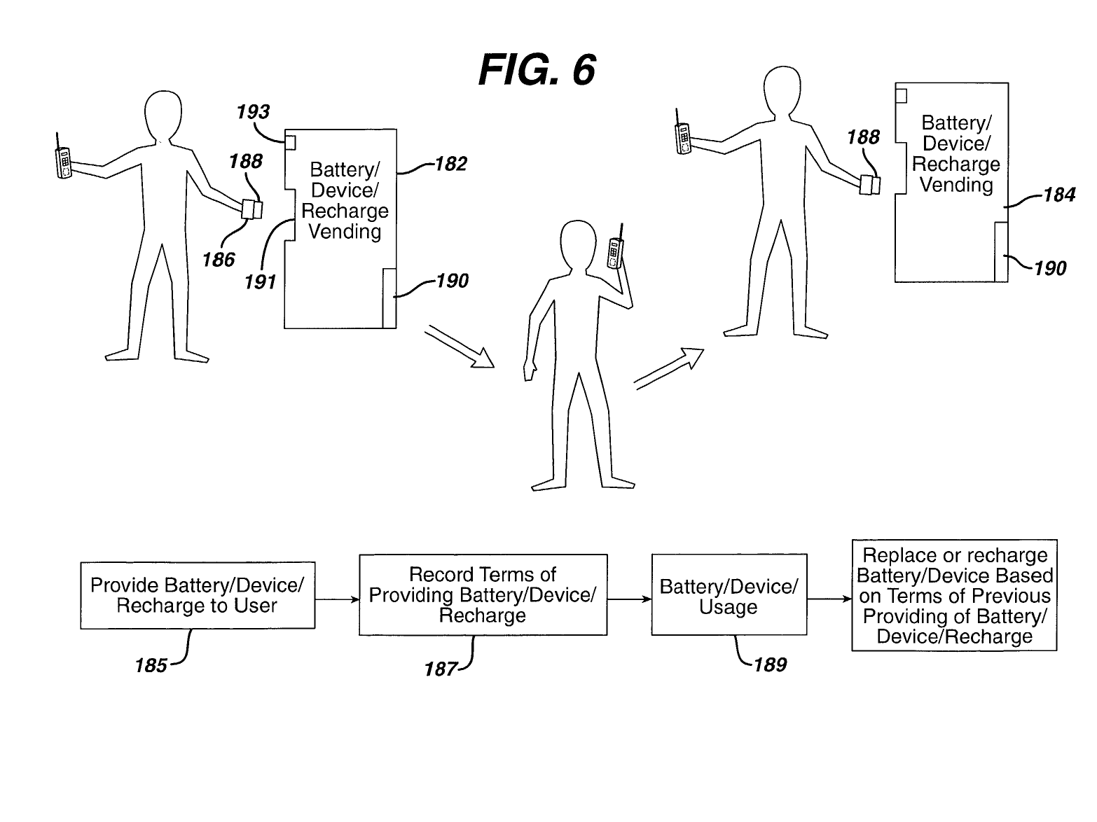

Referring to FIG. 6, an embodiment of a vending system including external vending machines 182, 184 at various locations is illustrated. The battery user may obtain or recharge 185 a battery 186 (or a device, such as a phone, including a battery or other power source) at a vending machine 182. For example, the vending machine may include a receptacle 191 into which the battery is placed for recharging. Alternatively, the battery may be removed through a mechanical means, such as a conveyor, from the receptacle into the interior of the station where it is stored and/or recharged, and a fresh device or battery is then provided to the user through the receptacle. The vending machine may include a payment receptacle 193 that accepts, for example, cash, a credit card, a prepaid card, or an account number from the user. At the time of the transaction, the terms of the transaction are recorded 187 in a battery module 188.

As the user utilizes the device 189, the battery is discharged. At the time of recharge or replacement, the user inserts the battery (or device) into a vending machine 184. The terms of the previous transaction are communicated from the battery module 188 to the vending machine 184. The vending machine includes a module 190 that computes a fee for recharge or replacement. The fee may be dependent on terms of prior transactions. For example, if the user paid a lower fee for the prior transaction, the fee for replacement or recharge may be less than if the user paid a higher fee for the prior transaction.

As discussed above, the vending stations may operate by communicating usage and/or transaction terms through a distribution channel to a usage monitor. Alternatively or in addition, the vending stations may operate as stand-alone devices communicating only with the battery or device and without communicating across a communication channel to a central monitor.

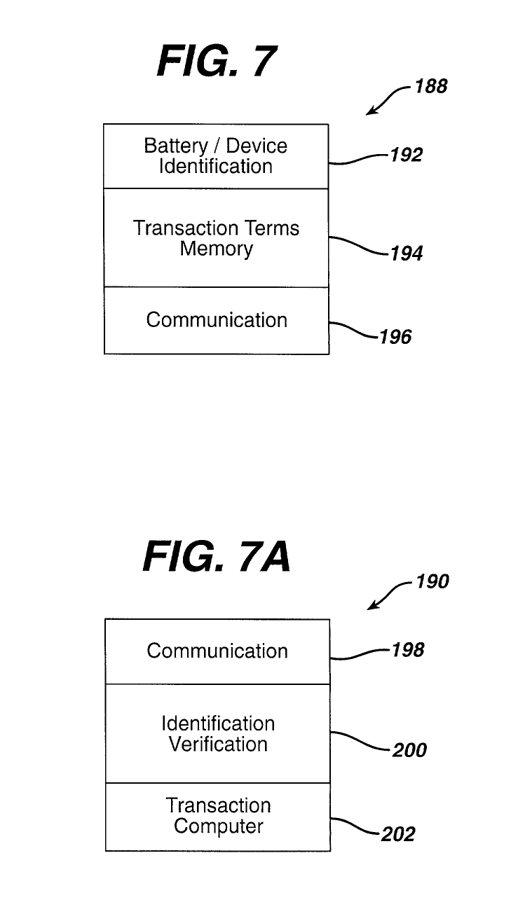

Referring to FIGS. 7 and 7A in an embodiment, a battery module 188 may include a series of sub-modules, including an identification module 192, a transactions term memory module 194, and a communications module 196. The identification module 192 identifies the battery. The transaction term module records the terms of prior transactions, such as the fee for obtaining the battery or a prior recharge. The communication module communicates this information externally. Referring particularly to FIG. 7A, the vending stations module 190 includes a communication sub-module 198, identification verification sub-module 200, and transaction computer 202. The communications sub-module 198 receives communication from the battery module such as battery identification and the terms of the previous transaction. The identification verification module 200 verifies the identification of the battery and determines whether it is suitable for replacement or recharge. The transaction computer 202 computes the terms of replacement or recharge of the battery. The basis for the terms may be provided by hardware or software that is periodically replaced, either manually at the vending machine or remotely through a communication channel. The transaction terms may be communicated to the battery and stored in the battery transaction memory.

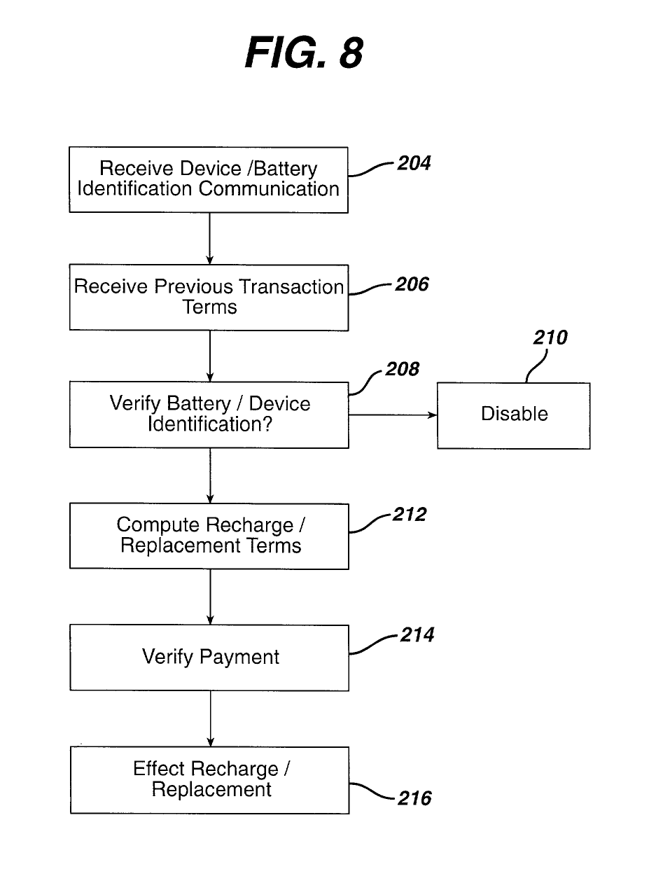

Referring to FIG. 8, the operation of the vending station is illustrated. The device or battery is first placed on the station by the user. For example, the battery module may include a port which mates with a port on the vending station. The vending station then receives 204 the device or battery identification and receives 206 the previous transaction terms. The battery or device identification is verified 208. If the battery or device is not identified as a battery or device suitable for replacement or recharge, the operation is disabled 210. If the battery or device is suitable for recharge, the terms for recharge or replacement are computed 212. The station then verifies 214 that the user has entered payment, e.g., by cash, prepaid card, or, if the vending station can communicate with a remote billing system, a credit card. If payment is made, the station affects recharge or replacement. The system may also communicate the terms of the transaction to the battery. The vending station may also measure the amount of energy dispensed by a recharge. Alternately, the vending station may store and later recharge the used battery and dispense a new or freshly charged battery immediately upon payment.

Many other variations are possible. While usage modules have been illustrated above in connection with the battery and the charger, a usage module could as well or instead be provided in the device in which the battery is used. For example, the device may include a module with device identification, verification, communication and disable functions, while the battery includes only a battery identification module. This example simplifies the battery module. The modules may be circuitry, including purpose-designed programmable microchips which are permanently or removeably attached to the battery, device, recharger, vending station or the like.

The battery may be of various types, including primary or rechargeable alkaline, metal-air, or other storage-type batteries. While there are particular advantages to rechargeable batteries, the communication systems can be used with non-rechargeable batteries. For example, a user who utilizes the battery in a business can be provided with non-rechargeable batteries at low or no cost and the usage monitored. The billing includes a record of usage as a function of date, and/or a user-entered event. The business user can then account for the power usage for a given customer. The system can also be used with other portable power equipment including portable generators and solar powered devices. The portable power source may be permanently integrated or attached to the device or it may be removable. The communication from the device or battery may be information other than or in addition to usage. For example, the communication could indicate the number and type of devices in which a battery is installed. The fee could be based on the type of device and be reflective of the cost of the use of the device, rather than just the battery. Likewise, the communication from the monitor may be other than usage based. For example, the communication may be advertising selected based on the type of devices in which a battery is installed. The communication may be to one other than the user. Alternatively, communication with the user or third party may be omitted entirely. The information communicated to the monitor may be used by the manufacturer or others for analysis of battery performance and/or to obtain business data. The communication from the battery can also include charge/discharge characteristics, which can be, e.g., periodically transmitted to an external source for analysis and modification to optimize battery performance. Maintaining and adjusting charge/discharge characteristics of a battery is discussed in U.S. Pat. No. 5,633,573 and U.S. Pat. No. 5,691,021, the entire contents of both of which are hereby incorporated by reference. The usage of various devices can be monitored by monitoring power usage as discussed above, including telephones, computers, and other devices, including non-communication devices, e.g., power tools or personal care products such as electric razors and tooth brushes.

Still further embodiments are within the following claims.

What is claimed is:

1. A method comprising:
providing a battery to a user and,
communicating battery usage to a remote monitor.

2. The method of claim 1 wherein the usage is communicated by transmitting a signal representative of the usage over the Internet.

3. The method of claim 1 or 2 wherein the usage is communicated by a wireless channel.

4. The method of claim 1 comprising communicating with the user based on the usage.

5. The method of claim 4 comprising communicating a bill based on the usage.

6. The method of claim 5 wherein the bill is communicated to the user by the Internet.

7. The method of claim 1 comprising providing the battery to the user without a purchase fee.

8. The method of claim 1 comprising providing the battery in a device to a user without a purchase fee.

9. The method of claim 8 wherein the device is a communication device.

10. The method of claim 9 wherein the usage is communicated by the device.

11. The method of claim 1 wherein the battery is a rechargeable battery.

12. The method of claim 1 wherein the battery is a single use battery.

13. The method of claim 11 wherein the battery usage is based on recharge cycles.

14. A method, comprising:
providing a battery or a battery-powered device to a user;
determining the usage of the battery or the device, and/or the terms of providing the battery or device; and
determining a fee based on the usage and/or the terms.

15. The method of claim 14 comprising:
communicating the usage and/or terms to an external monitor.

16. The method of claim 15 comprising:
transmitting the usage and/or terms over the Internet.

17. The method of claim 14 comprising:
recording the usage and/or terms in a module attached to the battery, the device, or a recharger for recharging the battery or device.

18. The method of claim 14 comprising:
providing a plurality of vending stations that dispense and/or recharge said battery or device, where the fee for replacement or recharging is based on the usage and/or said terms.

19. The method of claim 14 comprising:
providing a rechargeable battery or a device with a rechargeable battery.

20. The method of claim 14 comprising:
providing a single-use battery or battery-powered device with a single use battery.

21. A battery including an electronically readable identification module and a usage module.

22. The battery of claim 21 including a communication device facilitating communication of usage to an external device.

23. The battery of claim 21 further including a battery device detector that detects the device in which the battery is installed.

24. The battery of claim 23 wherein the detector verifies the installed device as a permissible device.

25. The battery of claim 21 including a disabler capable of disabling battery use.

26. The battery of claim 21 wherein the battery is a rechargeable battery.

27. A battery having attached thereto an electrically readable terms module, including a representation of battery acquisition and/or recharge terms.

28. The battery of claim 27 including an identification module.

29. The battery of claim 27 including a communication device for facilitating communication to an external device.

30. The battery of claim 27 including a usage module.

31. The battery of claim 27 wherein the battery is a rechargeable battery.

32. A vending station, comprising:
a device or battery recharging or dispensing apparatus; and
a terms module for determining the terms under which a battery or device will be recharged or dispensed.

33. The vending station of claim 32 including a module for determining from a battery or device previous terms under which the battery or device was provided to a user and/or recharged.

34. The vending station of claim 32 comprising an identification apparatus which determines whether a battery or device is suitable for recharge or replacement.

35. The vending station of claim 33 or 34 including a device or battery receiving apparatus that receives a battery or device from a user.

36. The vending station of claim 32 including a payment receptacle capable of receiving a prepaid card or a credit card.

37. A battery charging apparatus including a communication module capable of facilitating communication related to the use of the charger or a battery installed in the charger.

38. The charging apparatus of claim 37 including an identification module.

39. The charging apparatus of claim 37 including a verification module for verifying an installed battery/or device as a permissible battery and/or device.

40. The charging apparatus of claim 37 including a disabler.

41. An external monitor comprising:
a communication module adapted to receive a communication of battery identification and/or usage;
an account storage module to store the identification and usage information; and
a billing module to initiate billing based on the identification and usage information.

42. An external monitor including:
a communication module adapted to receive a communication of terms and/or usage of a battery and/or device; and
a transaction computer adapted to compute a fee based on the terms and/or usage.

43. A system for using a battery or battery-powered device, comprising:
a battery or battery-powered device having an identification module;
a battery usage and/or terms detector;
an external monitor capable of receiving identification and/or usage and/or terms information; and
a communication apparatus for communicating identification and usage to the external monitor.
